(19) United States
(12) Patent Application Publication
(10) Pub. No.: US 2010/0100854 A1
(43) Pub. Date: Apr. 22, 2010

(54) GESTURE OPERATION INPUT SYSTEM

(75) Inventors: Deborah C. Russell, Austin, TX (US); Roy Stedman, Austin, TX (US); Bradley Michael Lawrence, Austin, TX (US)

Correspondence Address: HAYNES AND BOONE, LLP;IP Section, 2323 Victory Avenue, Suite 700, Dallas, TX, 75219, US

(73) Assignee: Dell Products L.P., Round Rock, TX (US)

(21) Appl. No.: 12/252,932

(22) Filed: Oct. 16, 2008

(51) Int. Cl. G06F 3/033

(52) U.S. Cl. 715/863

(57) ABSTRACT

A gesture operation input system includes one or more subsystems to receive an input indicating a modifier input, receive a gesture input, wherein the gesture input indicates an action to be performed, and receive an indication that the modifier input is no longer being received. After receiving the gesture input, the gesture operation input system then determines the action to be performed using the gesture input and performs the action.

### BACKGROUND

The present disclosure relates generally to information handling systems, and more particularly to a gesture operation input system for an information handling system.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Certain IHSs allow users of the IHS to perform functions using a multi-touch gesture library. The gesture library is generally a variety of motions provided to the IHS to get the IHS to perform a function. The gesture library, however, is so complex it is difficult for one to remember all the gestures. For example, gestures may require the user to use a thumb and one or more fingers of the same hand to perform the gesture motions. This use of multiple fingers on the same hand performing different motions may be difficult for operators. The gestures may interfere with the visibility of images on the display, reduce visual efficiency, and elicit dexterity discomfort. In addition, the gesture library/hand strokes may not be intuitive to the average IHS user.

Accordingly, it would be desirable to provide an improved gesture operation input system absent the disadvantages discussed above.

### SUMMARY

According to one embodiment, a gesture operation input system includes one or more subsystems to receive an input indicating a modifier input, receive a gesture input, wherein the gesture input indicates an action to be performed, and receive an indication that the modifier input is no longer being received. After receiving the gesture input, the gesture operation input system then determines the action to be performed using the gesture input and performs the action.

### BRIEF DESCRIPTION OF THE DRAWINGS

FIG. 1 illustrates a block diagram of an embodiment of and information handling system (IHS).

FIG. 2 illustrates a flow chart of an embodiment of a method for an IHS to receive gesture inputs.

FIG. 3 illustrates a flow chart of an embodiment of a method for an IHS to receive gesture inputs.

FIG. 4 illustrates an embodiment of and IHS with a gesture operation input system.

### DETAILED DESCRIPTION

For purposes of this disclosure, an IHS 100 includes any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an IHS 100 may be a personal computer, a network storage device, or any other suitable device and may vary in size, shape, performance, functionality, and price. The IHS 100 may include random access memory (RAM), one or more processing resources such as a central processing unit (CPU) or hardware or software control logic, read only memory (ROM), and/or other types of nonvolatile memory. Additional components of the IHS 100 may include one or more disk drives, one or more network ports for communicating with external devices as well as various input and output (I/O) devices, such as a keyboard, a mouse, and a video display. The IHS 100 may also include one or more buses operable to transmit communications between the various hardware components.

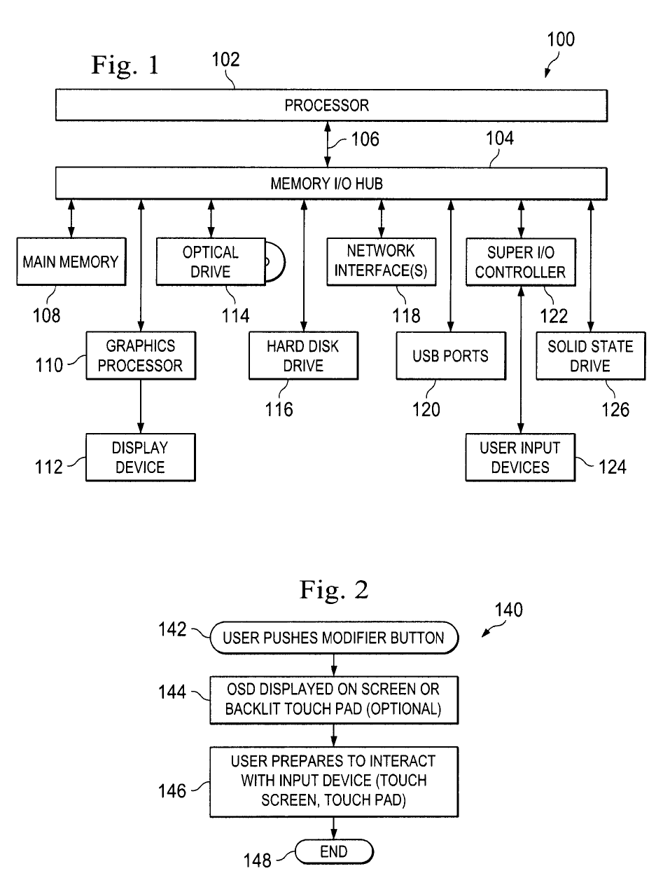

FIG. 1 is a block diagram of one IHS 100. The IHS 100 includes a processor 102 such as an Intel Pentium™ series processor or any other processor available. A memory I/O hub chipset 104 (comprising one or more integrated circuits) connects to processor 102 over a front-side bus 106. Memory I/O hub 104 provides the processor 102 with access to a variety of resources. Main memory 108 connects to memory I/O hub 104 over a memory or data bus. A graphics processor 110 also connects to memory I/O hub 104, allowing the graphics processor to communicate, e.g., with processor 102 and main memory 108. Graphics processor 110, in turn, provides display signals to a display device 112. In an embodiment, the display device 112 may be a touch screen display device. A touch screen display device allows the IHS 100 to receive input from a user via the display device 112.

Other resources can also be coupled to the system through the memory I/O hub 104 using a data bus, including an optical drive 114 or other removable-media drive, one or more hard disk drives 116, one or more network interfaces 118, one or more Universal Serial Bus (USB) ports 120, and a super I/O controller 122 to provide access to user input devices 124, etc. The IHS 100 may also include a solid state drive (SSDs) 126 in place of, or in addition to main memory 108, the optical drive 114, and/or a hard disk drive 116. It is understood that any or all of the drive devices 114, 116, and 126 may be located locally with the IHS 100, located remotely from the IHS 100, and/or they may be virtual with respect to the IHS 100.

Not all IHSs 100 include each of the components shown in FIG. 1, and other components not shown may exist. Furthermore, some components shown as separate may exist in an integrated package or be integrated in a common integrated circuit with other components, for example, the processor 102 and the memory I/O hub 104 can be combined together. As can be appreciated, many systems are expandable, and include or can include a variety of components, including redundant or parallel resources.

A gesture operation input system allows a user of an IHS 100 to dynamically and easily interact with the IHS 100 via touch gestures. In an embodiment, the user of the IHS 100 draws a symbol or character on a touch surface with a finger, stylus, or other device while engaging a modifier. The modifier may be a keyboard key, a switch, a button, or other similar input device. In addition, the modifier may be a real, physical device or a virtual device on a touch screen, touch pad, or the like. Using a modifier and a character/symbol rather than using multiple fingers on the same hand is easier to perform and requires less hand dexterity than other gesture systems. In other words, it is easier to have a shortcut system that allows users to “draw” the desired functionality via a character by pressing a touch modifier to capture the character and execute the desired behavior. By pressing a touch modifier, the user can perform special operations similar to use of the control key on a keyboard (e.g., draw a “P” to print a file).

In an embodiment, the gesture operation input system of the present disclosure utilizes control key shortcuts available in software applications. In other words, an embodiment of the present disclosure provides a system for using a modifier key (e.g., a control key, a dedicated modifier key, or other modifier input) in which the user of the IHS 100 draws a character or symbol to execute some behavior for any IHS application. For example, modifier button plus: B=bold; C=cut; I=italics; N=new; P=print; Z=undo, and a variety of other characters and symbols may be used. Thus, embodiments of the present disclosure may operate with any operating system and any application.

It is to be understood that the gesture operation input system of the present disclosure may use a touch interaction following the launch of an application on the IHS 100. In addition, the system may operate on notebooks, desktop displays, all-in-ones, telephones, media devices (e.g., MP3 devices), keyboards, and any other device that utilizes a touch screen or other input area and applications with embedded control+key or similar type commands. It is to be understood that a software for this system may operate with or without toolbars and may operate with word processing, spreadsheets, slide presentations, scrapbooks, gaming, and a variety of other applications. The gesture system of the present disclosure may perform various data manipulations in the file by capturing/selecting areas data from an area of a document, printing, pasting, and/or performing other operations in the application.

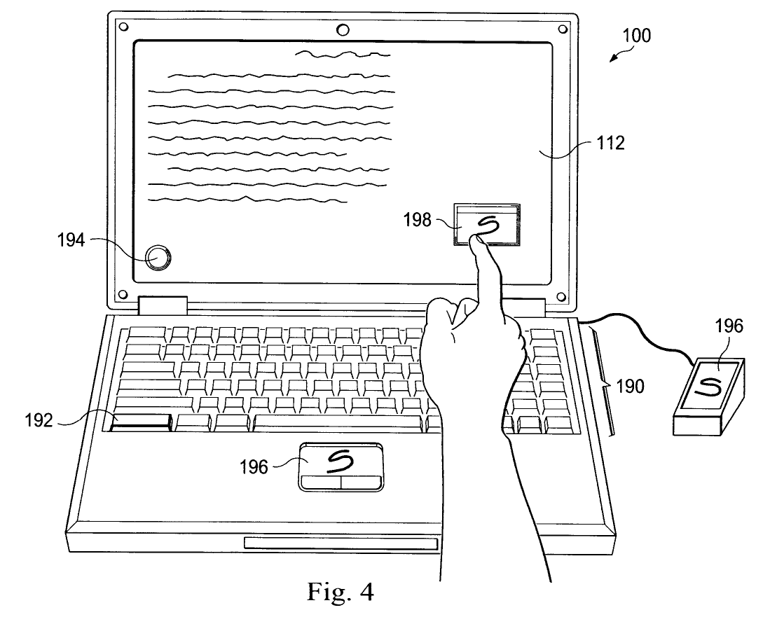

FIG. 2 illustrates a flow chart of an embodiment of a method 140 for an IHS 100 to receive gesture inputs. The method 140 begins at block 142 when a user of an IHS 100 engages a modifier button, such as a control key 192 on a keyboard 190 or an on-screen virtual modifier button 194 on display device 112, as shown in FIG. 4. The method 140 then proceeds to block 144 where the method 140 displays an input screen, such as the input screen 198 on the display device 112 or the method 140 highlights/backlights a touchpad 196, as shown in FIG. 4. The touchpad 196 may be incorporated into the IHS 100 or may be a stand alone device. The method 140 then proceeds to block 146 where the user may then interact with the IHS 100 via the input device (e.g., the touch pad 196 or the input screen 198). Then, the method 140 ends at block 148. After the IHS 100 receives the gesture input, the IHS 100 may recognize the gesture input and perform any function.

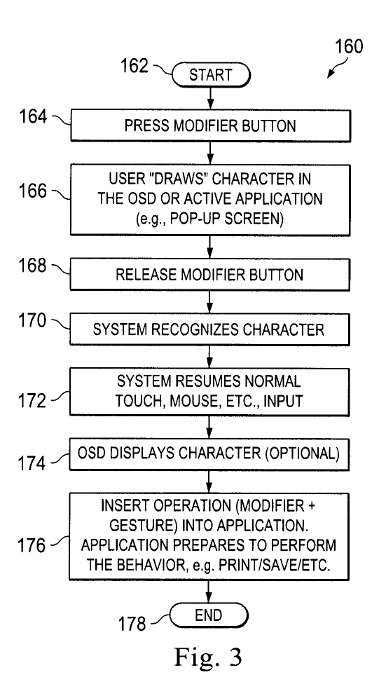

FIG. 3 illustrates a flow chart of an embodiment of a method 160 for an IHS 100 to receive gesture inputs. The method 160 begins at block 162 where the IHS 100 is operating and capable of receiving an input from a user via a modifier button 192, 194. The method 160 proceeds to block 164 when a user of the IHS presses or otherwise engages a modifier button 192, 194. After the modifier button 192, 194 is engaged, the IHS 100 may pop-up an input screen 198 or activate/illuminate a touchpad 196 to indicate to the user that the user may write, draw, or otherwise enter a gesture on the input device 196, 198. The method 160 then proceeds to block 166 where the user of the IHS 100 inputs the gesture into the input device 196, 198. Next, the method 160 proceeds to block 168 where the user releases the modifier button 192, 194. It should be understood that in an embodiment, the method 160 may operate by having the engagement of the modifier button 192, 194 become a latching button where the engagement of the modifier 192, 194 latches on until the user presses the modifier button 192, 194 a second time or some other system releases the latching modifier. Next, the method 160 proceeds to block 170 where the method 160 recognizes the gesture input. In an embodiment, the gesture inputs may follow common control+key type inputs, such as those provided in Table 1. However, other gesture inputs may be used for these and other operations (e.g., shift key+control key+a “T” gesture could indicate cropping on the application).

TABLE 1
Modifier + Gesture input operations

| Modifier + Gesture | Operation |
|---|---|
| Modifier + A | Select All |
| Modifier + B | Bold |
| Modifier + C | Copy (can also be used as an alternative |
| | to Modifier + Break to terminate an |
| | application) |
| Modifier + D | Font Window (Word Processing) |
| Modifier + E | Center Alignment (Word Processing) |
| Modifier + F | Find (usually a small piece of text in a |
| | larger document) |
| Modifier + G | Go to (Line Number) |
| Modifier + H | Replace, or History in browsers |
| Modifier + I | Italic |
| Modifier + K | Insert Hyperlink (Word processing) |
| Modifier + L | Create List |
| Modifier + M | Decrease Margin |
| Modifier + N | New (window, document, etc.) |
| Modifier + O | Open |
| Modifier + P | Print |
| Modifier + Q | Quit Application |
| Modifier + R | Refresh Page |
| Modifier + S | Save |
| Modifier + T | Open New Tab |
| Modifier + U | Underline |
| Modifier + V | Paste |
| Modifier + W | Close window or tab |
| Modifier + X | Cut |
| Modifier + Y | Redo (sometimes ctrl + shift + Z is used for |
| | this) |
| Modifier + End | Bottom (end of document or window) |
| Modifier + Home | Top (start of document or window) |
| Modifier + Ins | Copy |
| Modifier + PgDn | Next tab |
| Modifier + PgUp | Previous tab |
| Modifier + Tab | Next window or tab |
| Modifier + Shift + Tab | Previous window or tab |
| Modifier + ← | Previous Word |
| Modifier + → | Next Word |
| Modifier + Delete | Delete Next Word |
| Modifier + Backspace | Delete Previous Word |
| Modifier + Alt + Delete | Task Manager/Restarting the Computer |

The method 160 then proceeds to block 172 where the system recognizes that the modifier 192, 194 is no longer engaged and resumes normal inputs, such as keyboard, mouse, touch screen, and any other inputs. In an embodiment, the method 160 proceeds to block 174 where the method 160 displays the received gesture on the touch pad 196 and/or on the input screen 198. For example, as shown in FIG. 4, the method 160 may display the character “S” as the input gesture on the input pad 196 and/or on the input screen 198 after the user engages the modifier 192, 194 and then the user inputs the character “S” into the touch pad 196 or the input screen 198 of a touch screen display device 112, using the user's finger, a stylus, or other input device. As shown in Table, 1, the gesture “S” may be used to save a copy of the document, spreadsheet, slide presentation, or other application. The method 160 then proceeds to block 176 where the method 160 performs the operation (e.g., the save operation when a “S” gesture is provided) in the application operating on the IHS 100. The method 160 then ends at block 178 where the operation running on the IHS 100 returns to normal operation.

A touch interaction as disclosed in the present application may utilize one-finger movements for each hand and thus differentiates Windows® operating system users from Mac® operating system users. The present disclosure also reduces a learning curve to touch interaction for controlling the IHS 100. Additionally, embodiments of this touch interaction may work across any application, may be specific to all languages, do not require continuous movements without raising the writing device, work on touch screens and touch pads and promotes new design interfaces for software applications.

It should be readily understood by a person having ordinary skill in the art that the systems and methods of the present disclosure solves several problems associated with IHS touch interaction. First, the systems and methods of the present disclosure reduces the difficulty and ambiguity associated with multi-touch gestures. For example, an embodiment of the present disclosure utilizes an application's Control+Key library. In addition, the present disclosure may be applied with the Apple®+Key used for Apple® computers. Second, embodiments of the systems and methods of the present disclosure do not create another language, but rather treat touch interaction synonymous with traditional keyboard commands. As such, users who are familiar with shortcut command keys can easily user their knowledge to operate the present disclosure. Third, existing software applications do not need additional programming such as gesture application programming interfaces (APIs) or software development kits (SDKs). If software applications implement shortcut keys, the present systems may leverage that application's command key library. Fourth, the systems and methods of the present disclosure make touch interaction simple by only requiring a single finger interaction on each hand, which is more ergonomic and requires less hand dexterity than systems requiring use of multiple fingers on the same hand to perform the gestures. Fifth, the systems and methods of the present disclosure may work using any IHS application that implements shortcut command key behaviors. Thus, the present disclosure may use a touch modifier key 192, 194, which could be in the form of a capacitive button on a bezel, a dedicated area on a touchpad, a fixed icon the touch screen or other input systems. The modifier key 192, 194 may be programmed to behave similar to the control key 192. In an embodiment, when the user of the IHS 100 presses and holds the modifier key 192, 194 with one finger on a first hand, one finger from a second hand may be used to draw the gesture command key character on a dedicated display 196, 198. The on-screen display 198 may be optional for advanced IHS users. Users may use their finger, a stylus and/or any other device to input the gesture character into the input device 196, 198. Similar to hand-writing recognition applications, the interface of the present disclosure may be programmed to recognize the characters for faster learning. Sixth, the systems and methods of the present disclosure are not be constrained by continuous and simultaneous writing movements as are other gesture systems. Rather, users draw the command key character (printed or cursive) as they would see it on a keyboard (e.g., draw an “X” by making a first diagonal line, picking up the writing device and then making a second diagonal line crossing the first diagonal line, rather than making a variation of an “X” made without lifting the writing finger or instrument). Seventh, the systems and methods of the present disclosure may be global and work anywhere as the application implemented command functions. For example, users could draw Asian characters and the characters may be recognized by the interface. Finally, the systems and methods of the present disclosure may allow software developers to create unique software applications in which the interfaces do not have to implement a traditional menu or tool bar. Rather, the present disclosure may allow more direction object manipulation with a touch screen, reduce visual clutter (i.e., tool bar), and make an interface more inviting.

It is also to be understood that in an embodiment of the present disclosure, the applications themselves may define their own hot keys and what they do on a per-application basis. Thus, the present disclosure gets the character/gesture input from the user, converts it into a character, adds the modifier 192, 194, (e.g., the ‘alt’ key, the ‘ctrl’, etc.) and hands that character combination to the application for it to process.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A gesture operation input system comprising one or more subsystems to:
receive an input indicating a modifier input;
receive a gesture input, wherein the gesture input indicates an action to be performed;
receive an indication that the modifier input is no longer being received;
determine the action to be performed using the gesture input; and
perform the action.

2. The gesture operation input system of claim 1, further comprising displaying the gesture input for a user to see what gesture input is received.

3. The gesture operation input system of claim 1, wherein the input indicating a modifier input is received using a keyboard or a touch screen display device.

4. The gesture operation input system of claim 1, wherein the gesture input is received using a touch screen display device.

5. The gesture operation input system of claim 1, wherein the gesture input is received using a touch pad.

6. The gesture operation input system of claim 1, wherein the input indicating a modifier input is to be engaged while the gesture input is received.

7. The gesture operation input system of claim 1, wherein the gesture input that indicates an action to be performed is a standard alphabetic character.

8. An information handling system (IHS) comprising:
a processor;
a modifier input device;
a gesture input device; and
a gesture operation input system comprising one or more subsystems to:
receive an input via the modifier input device indicating a modifier input;
receive a gesture input via the gesture input device, wherein the gesture input indicates an action to be performed;
receive an indication that the modifier input is no longer being received;
determine the action to be performed using the processor and the gesture input; and
perform the action.

9. The IHS of claim 8, further comprising displaying the gesture input for a user to see what gesture input is received.

10. The IHS of claim 8, wherein the input indicating a modifier input is received using a keyboard or a touch screen display device.

11. The IHS of claim 8, wherein the gesture input is received using a touch screen display device.

12. The IHS of claim 8, wherein the gesture input is received using a touch pad.

13. The IHS of claim 8, wherein the input indicating a modifier input is to be engaged while the gesture input is received.

14. The IHS of claim 8, wherein the gesture input that indicates an action to be performed is a standard alphabetic character.

15. A method to operate a gesture input system comprising:
receiving an input indicating a modifier input;
receiving a gesture input, wherein the gesture input indicates an action to be performed;
receiving an indication that the modifier input is no longer being received;
determining the action to be performed using the gesture input; and
performing the action.

16. The method of claim 15, further comprising displaying the gesture input for a user to see what gesture input is received.

17. The method of claim 15, wherein the input indicating a modifier input is received using a keyboard or a touch screen display device.

18. The method of claim 15, wherein the gesture input is received using a touch screen display device.

19. The method of claim 15, wherein the gesture input is received using a touch pad.

20. The method of claim 15, wherein the input indicating a modifier input is to be engaged while the gesture input is received and wherein the gesture input that indicates an action to be performed is a standard alphabetic character.
